(19) United States
(12) Patent Application Publication
(10) Pub. No.: US 2008/0319837 A1
(43) Pub. Date: Dec. 25, 2008

(54) Pay Parking System and Method

(76) Inventor: Frederick L. Mitschele, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/064,296

(22) PCT Filed: Aug. 21, 2006
(86) PCT No.: PCT/CA06/01372

§ 371 Date: Jun. 9, 2008

Related U.S. Application Data
(60) Provisional application No. 60/711,690, filed on Aug. 29, 2005.

(51) Int. Cl. G06Q 30/00

(52) U.S. Cl. 705/13

(57) ABSTRACT

A parking meter system where a vehicle detector is coupled with a microcontroller for detecting the presence or absence of a vehicle in the associated parking space has a plurality of monitoring units communicating with a single unit for accepting payment by coin, credit card or both. In this way the cost of installing and main-taining the system is reduced.

### CROSS-REFERENCE TO RELATED APPLICATIONS

This application claims priority from U.S. provisional patent application No. 60/711,690 filed Aug. 29, 2005 which is pending and which is incorporated herein by reference.

### TECHNICAL FIELD

The present invention relates to pay parking systems and, more particularly, parking systems utilizing apparatus which detect the presence or absence of a vehicle.

### BACKGROUND ART

Prior parking meters are known which increase revenues by detecting the presence or absence of a vehicle. U.S. Pat. No. 4,823,928 which issued to POM Incorporated in 1989, describes an electronic parking meter system that resets the timing circuit to zero when a vehicle is no longer detected in the associated parking space. The POM Incorporated parking meter is placed in an operational mode when a coin is deposited. When placed in the operational mode, a sonar range finder is turned on which detects the presence or absence of a vehicle in the associated parking space. The sonar range finder provides a signal to a microprocessor controller when the vehicle is no longer in the associated parking space, and the microprocessor controller resets the timer.

While the POM Incorporated parking meter assists in maximizing parking meter revenues, it does not catch parking meter violations. In order to catch parking meter violations, parking meter attendants and parking by-law enforcement officers patrol the streets. Typically, comparatively few enforcement officers are charged with responsibility for a huge number of parking meters, so enforcement is random, at best. This problem was addressed in the present inventor's U.S. Pat. No. 5,777,951, which is incorporated herein by reference. That patent discloses a parking meter system in which a camera is used to record and store the image of the license plate of a parking violator. A microcontroller initiates a timer for a prepaid parking interval upon receiving a signal that a payment has been accepted. Vehicle detection means is coupled with the microcontroller for detecting the presence or absence of a vehicle in the associated parking space. The microprocessor initiates a digital camera to take an image of the vehicle licence plate upon the vehicle detection means signalling to the microprocessor the presence of the vehicle in the associated parking space after the timer has signalled to the microprocessor the expiration of the prepaid parking interval.

An enhanced parking meter system is disclosed in the present inventor's International application no. PCT/CA99/00896, published Apr. 5, 2001 under no. WO 01/24127, which is also incorporated herein by reference. The license plate of a vehicle is provided with an electronic tag such as an RFID which transmits the vehicle's unique identification number upon receipt of an external interrogation signal. The parking meter has a meter head carrying a payment mechanism, time display window, a vehicle detector, a microcontroller, a communications modem, and an interrogator which sends an interrogation microwave signal directed at the parking space, and receives the reflected coded signal from the license plate, decodes it and communicates the identification number to the microcontroller. The operation of the parking meter is initiated by a vehicle pulling into the associated parking space and its presence being detected by the vehicle detector. Upon occurrence of a parking violation, the microcontroller causes the interrogator to send an interrogation signal directed at the parking space, and receives the reflected coded signal from license plate. The reply signal is decoded and the identification number is communicated to the microcontroller for storage and/or a call is initiated through a communications modem notifying parking authorities as to a parking violation and providing the vehicle identification number.

### DISCLOSURE OF INVENTION

According to the present invention there is provided a pay parking system where a vehicle detector is coupled with a microcontroller for detecting the presence or absence of a vehicle in the associated parking space, which system has a plurality of monitoring units communicating with a single unit for accepting payment by coin, credit card or both. In this way the cost of installing and maintaining the system is reduced.

### BRIEF DESCRIPTION OF DRAWINGS

These and other features of the invention will become more apparent from the following description in which reference is made to the appended drawings, wherein:

FIG. 1 is a perspective view of a municipal street pay parking system having a single payment station and multiple units which detect the presence or absence of vehicles;

FIG. 2 is a detail perspective view of the payment unit and stall unit used with the system shown in FIG. 1;

FIG. 3 is a perspective view of a parking garage system having a single payment station and multiple stall units which detect the presence or absence of vehicles;

FIG. 4 is a perspective view of a second embodiment of a municipal street parking meter system or parking garage system having a single payment station and multiple units which detect the presence or absence of vehicles;

FIG. 5 is a perspective view of an embodiment of the municipal street pay parking system having a single payment station and multiple units which detect the presence or absence of vehicles and individual in-ground wireless cameras;

FIG. 6 is a perspective view of a parking garage system having a single payment station and multiple stall units which detect the presence or absence of a vehicle and individual in-ground wireless cameras;

FIG. 7 is a perspective view of a second embodiment of a municipal street pay parking system or parking garage system having a single payment station and multiple units which detect the presence or absence of vehicles and individual in-ground wireless cameras;

FIG. 8 is a perspective view of an in-ground wireless camera; and

FIG. 9 Is a flow chart illustrating the method of the invention.

### BEST MODE(S) FOR CARRYING OUT THE INVENTION

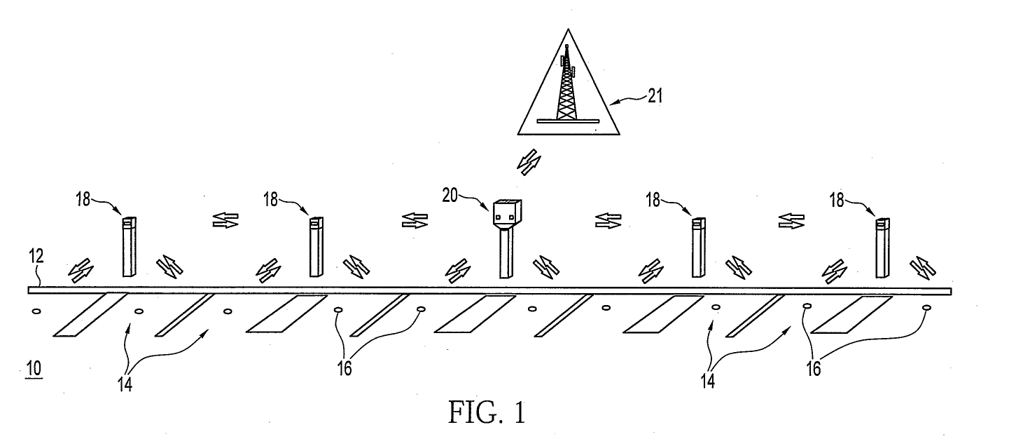

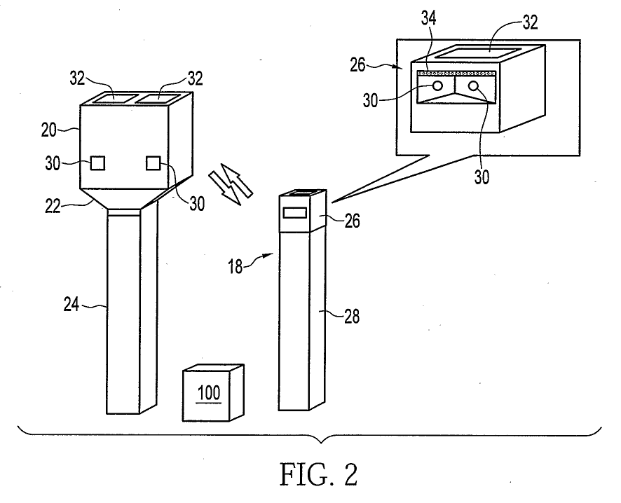

Referring to FIG. 1, municipal street 10 has curb 12 and a plurality of marked parking spaces 14, each with an in-ground vehicle sensor 16 and each marked with a unique identifier such as a number or alphanumeric. An example of such as in-ground sensor is the GROUND-HOG™ manufactured by Nu-metrics which is a wireless, self-contained, in-ground traffic monitor which transmits a wireless signal upon detection of a vehicle. Associated with each parking space 14 is either a pole unit 18 or payment unit 20, shown in further detail in FIG. 2 and as described below.

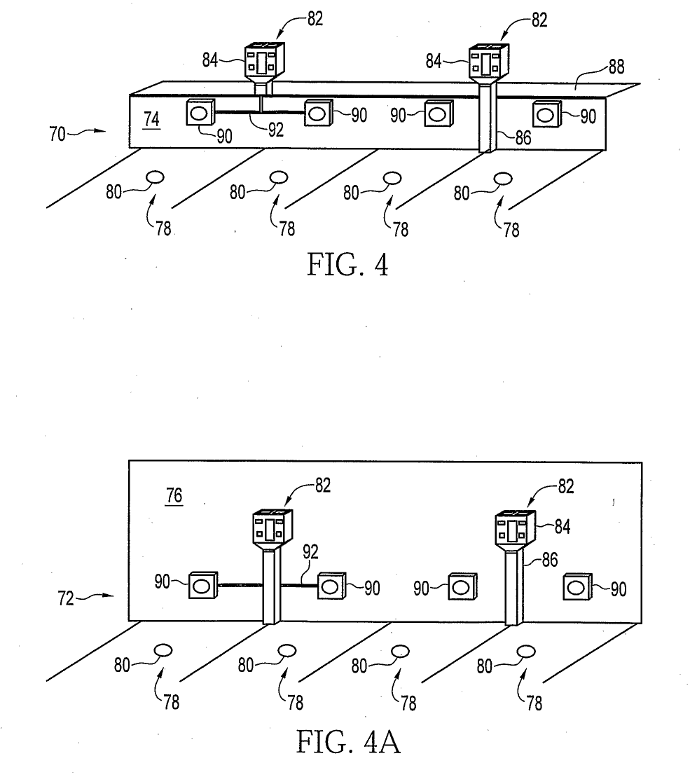

Payment unit 20 has the functionality of the parking meter described in International application no. PCT/CA99/00896. It includes, in its head 22 mounted on pole 24, a microcontroller, a timer coupled with and controlled by the microcontroller, and a payment acceptance mechanism coupled with the microcontroller. The payment acceptance mechanism can be configured to accept payment by coin, credit card or both for use of the associated parking space 14 and has a keypad tp permit the vehicle operator to enter information such as the parking space identifier. A communications modem is coupled with and controlled by the microcontroller. Two digital cameras 30 are focussed on associated parking spaces 14 and are coupled with and controlled by the microprocessor. By providing two cameras per unit 18, 20 in situations where parking is parallel to the curb, the system can be used in jurisdictions where vehicles have only a single license plate. Solar panels 32 provide power to charge a battery. LED lights 34 may be provided for operation of the camera in low lighting conditions. Pole units 18 have the same functionality as payment units 20 but lack the payment acceptance mechanism. Rather than using individuals pole units, two secondary units 90 can be supported off payment unit 82 by supporting arms 92 (FIG. 4).

Referring to FIG. 1, the pay parking operation, whether by pole unit 18 or payment unit 20, is initiated by a vehicle pulling into associated parking space 14 and its presence being detected by vehicle detector 16 which transmits a signal to associated unit 18 or 20, preferably wirelessly. The microcontroller initiates a timer in association with the parking space's identifier for a predetermined standby interval upon receiving a signal from vehicle detector 16 that a vehicle is present in associated parking space 14. The driver then makes a payment at payment unit 20 for a particular parking space by entering the parking space identifier, such as a parking stall number, which is communicated to the appropriate microcontroller. Should payment be made for use of associated parking space 14, the microcontroller will receive a signal from payment unit 20, terminate the timing of the standby interval and initiate the timer for a prepaid parking interval. A parking violation occurs when the operator of the vehicle either fails to make any payment or when the prepaid parking interval expires. Upon a parking violation, the microcontroller activates the digital camera 30 which is associated with the parking space identifier in question to take a digital image of the license plate of the vehicle to obtain the license number. If the vehicle is provided with an RFID identification tag, an RFID reader interrogates the tag, which emits a coded reply signal which communicates a vehicle identification code to the interrogating source which decodes it and either the identification number is stored with the violation information for later processing and/or a call is initiated through a communications modem notifying parking authorities at a monitoring station 21 as to a parking violation and providing the vehicle identification number. In either case a parking ticket is prepared, preferably with the digital image of the vehicle license and mailed to the registered owner of the vehicle.

As described in International application no. PCT/CA99/00896, digital camera 30 may function as both a vehicle sensor and vehicle identification means. By utilizing appropriate shape-distinguishing software, the image detected by the camera can be used to detect the presence or absence of a vehicle in the parking space 14. Camera 30 may be an infrared camera to function in low light situations.

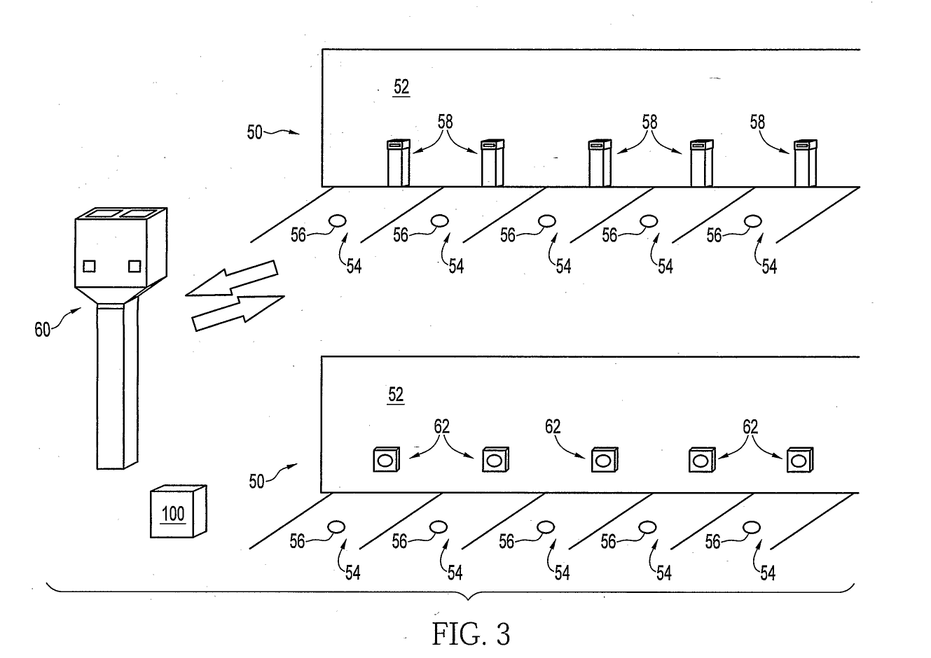

Referring to FIG. 3, a parking lot or garage 50 has wall 52 and a plurality of marked parking spaces 54, each with an in-ground vehicle sensor 56. Associated with each parking space 54 is a pole unit 58, as described above for unit 18 except that each unit 58 monitors one stall 54. Centrally located is a payment unit 60, having the features of payment unit 20 above except that it need not be used to monitor a parking stall and therefore may lack digital cameras. Pole units 58 can be replaced with wall-mounted units 62 which otherwise function in the same way.

The system can be adapted to an existing parking ticket dispenser having coin or credit card payment by means of an adaption box 100. In that case an adaption box having wired or wireless communication means is provided to interface between an existing parking ticket dispenser having coin or credit card payment and the pole units 18, 58, 62 and in-ground sensors 16, 56. In that way the existing parking ticket dispenser can be used as part of the system.

Referring to FIG. 4, a municipal parking lot 70 or garage 72 has walls 74, 76 and a plurality of marked parking spaces 78, each with an in-ground vehicle sensor 80. Associated with a pair of parking spaces 78 is a payment unit 82, as described above for unit 20 having a head 84 mounted on pole 86 or directly on a horizontal surface 88. Camera units 90 monitor each stall 78 as with units 62 above and may communicate with units 82 by wire or wireless and may be supported on arms 92 connected to unit 82 or directly to wall 74, 76. Camera units 90 have a digital cameras, microcontroller, battery and wireless or wired communication to in-ground sensors 80 and units 82 and otherwise function as described above. The battery may be charged by a solar panel.

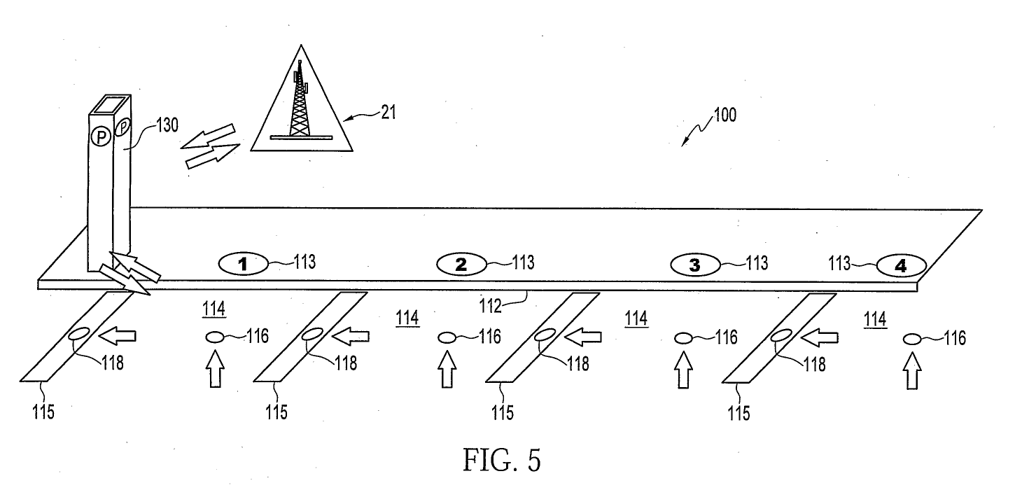

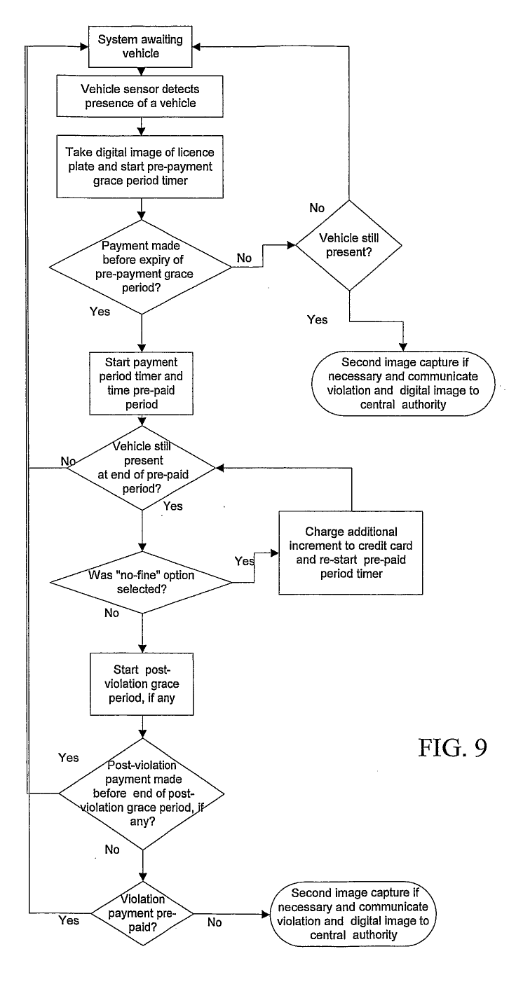

Referring to FIG. 5, a further embodiment of the pay parking system is disclosed in which the digital cameras are located in in-ground housings rather than on posts. A municipal street 100 has curb 112 and a plurality of marked parking spaces 114 separated by dividing lines 115, each with an in-ground vehicle sensor 116, as described above. Each space or stall 114 is marked with a unique number 113. The in-ground sensor is a wireless, self-contained, in-ground traffic monitor which transmits a wireless signal upon detection of a vehicle. Associated with each parking space 114 is also an in-ground wireless camera 118 (FIG. 9) which incorporates in housing 120 a digital camera 122, which also comprises a microcontroller, wired or wireless communication device and battery. A solar panel (not shown) may be included to charge the battery. Wireless communication can be via wilan, wifi, Bluetooth, gsm/gprs or other wireless protocol, and the units are addressable with an IP address. The vehicle sensor and camera could be incorporated into the single housing 120.

One or more centrally located payment units 130 are provided for the parking lot. Payment unit 130 is a pay-and-display, pay-by-stall device. It includes a microcontroller, a timer coupled with and controlled by the microcontroller, and a payment acceptance mechanism coupled with the microcontroller. The payment acceptance mechanism can be configured to accept payment by coin, credit card or both as described above. A communications modem is coupled with and controlled by the microcontroller and communicates with vehicle sensors 116 and cameras 118. The digital cameras 118 are focussed on associated parking spaces 114 and are coupled with and controlled by the microprocessor. Preferably a single camera 118 is used per stall, located on the dividing line and focussed on where the rear license plate of a parked vehicle will be located. In jurisdictions where vehicles have only a single license plate, it can be required that a vehicle park in one direction only, or two cameras per stall 114 can be provided.

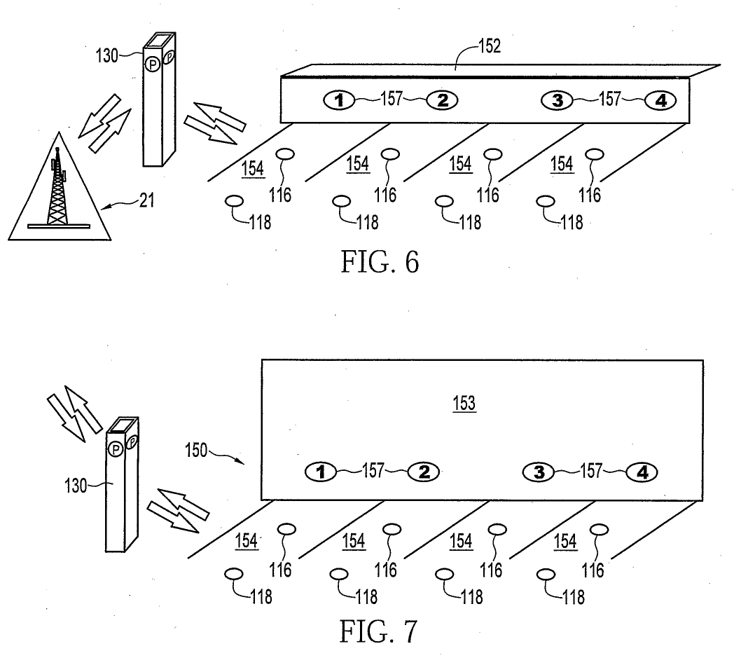

Referring to FIGS. 6 and 7, a parking lot or garage 150 has retaining wall 152 or garage wall 153 and a plurality of numbered parking spaces 154, each with an in-ground vehicle sensor 116. Each space or stall 154 is marked with a unique number 157. Associated with each parking lot is one or more centrally located payment units 130, having the features described above.

In the embodiments shown in FIGS. 5, 6 and 7, when a vehicle pulls into a parking space 114, 154 its presence is detected by vehicle detector 116 which transmits a signal to unit 130. The microcontroller initiates a timer in respect of that numbered stall for a predetermined standby interval upon receiving a signal from vehicle detector 116 that a vehicle is present in associated parking space 114, 154. The driver, either before or after entering the numbered stall, makes a payment at payment unit 130 for the particular numbered parking space by keying in the stall number and using coins or credit card. The microcontroller terminates the timing of the standby interval and initiates the timer for the prepaid parking interval. A parking violation occurs when the operator of the vehicle either fails to make any payment or when the prepaid parking interval expires. Upon a parking violation, the microcontroller activates the digital camera 118 associated with the numbered stall to take a digital image of the license plate of the vehicle to obtain the license number and either the image is stored with the violation information for later processing and/or a call is initiated through a communications modem notifying parking authorities at a monitoring station as to a parking violation and providing the license plate image. A parking ticket can then be prepared with the digital image of the vehicle license and mailed to the registered owner of the vehicle.

As described in International application no. PCT/CA99/00896, digital camera 118 may function as both a vehicle sensor and vehicle identification means. By utilizing appropriate shape-distinguishing software, the image detected by the camera can be used to detect the presence or absence of a vehicle in the parking space 14. Camera 30 may be an infrared camera to function in low light situations.

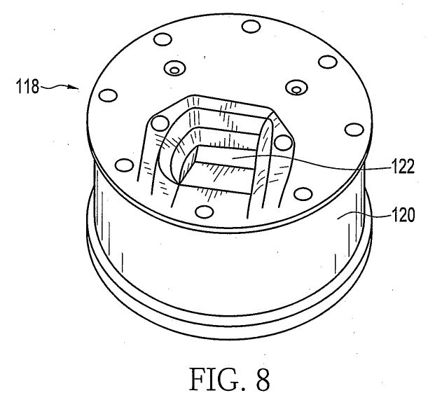

The in-ground vehicle sensors and wireless cameras shown in FIGS. 5 through 9 may also be used without a payment acceptance module to provide a self-enforcement monitoring of no-park zones. In that case the vehicle stall 114 represents a no-parking zone. The stationing of a vehicle in the no-parking zone will be detected by the in-ground sensor 116, which sends a wireless signal to a stand-alone controller 130, which may be located nearby, or via wireless internet connection to a remote server. After a certain time period the controller/server checks if the vehicle remains in the space. If it does the controller/server causes the in-ground camera 118 to take a picture of the vehicle license plate which is transmitted along with the date and time to the controller/server and then to the central station to prepare a violation ticket which is sent in the mail to the owner of the vehicle.

While the system can utilize any existing payment method, whether coins, bills or credit cards, the preferred payment methods are pre-payment by credit card or pay-as-you-go credit card payment. In the former the user pre-pays on a credit card in pre-selected pre-paid increments. When the pre-paid time expires, a violation is issued if the car has not left the parking spot. For a pay-as-you-go system, the user swipes a credit card to commence the parking time running. The user's card is pre-authorized to a maximum amount to ensure the card is valid, and then when the vehicle sensor senses that the vehicle has left the spot prior to the maximum charge time, then the pre-authorization is cancelled and the card is charged the exact amount of the parking cost. Alternatively, the user swipes the card again before leaving the space to stop the charge against the card. In the latter the system may be set up so that if the user forgets to re-swipe the card and leaves the space, the charge will continue to be made against the card, and if a second vehicle parks in the space, a charge will be made concurrently against the second user's card, until either user re-swipes his/her card or a maximum time period expires. According to an alternate approach, if the first user forgets to re-swipe his/her card, charging against that user's card ceases if a second user parks in the spot and swipes his/her card but recommences when the second user re-swipes his/her card and leaves the spot.

The use of the in-ground sensor permits a number of additional features to be provided in the above-described pay parking system.

In a typical configuration, an initial payment grace period, for example, up to 3 minutes, is provided to allow the driver to exit the vehicle and make payment. The microcontroller in payment unit 20 will be programmed to issue a parking violation and license image capture automatically after a vehicle has been sensed in a parking stall and the initial payment grace period has passed without payment. When the vehicle enters the parking space, the in-ground sensor 16 communicates the presence of the vehicle to unit 18 or 20 which takes a digital image of the license plate and commences the timer. A digital image of the license plate may be taken immediately on detection of the vehicle to avoid situations where the license is obscured or not visible when the violation event has occurred. After the timer has determined that the initial payment grace period has been exceeded without payment, then a parking violation is issued using the previously captured image and/or a second newly-captured image.

The initial payment grace period will typically not be charged as part of the parking time, but the charged time starts upon the driver making a cash or credit card payment. If no payment is made within the initial payment grace period, and the vehicle is still sensed withing the parking spot a violation is issued. According to one aspect, however, the controller can be programmed so that at the end of the initial payment grace period, the charged timing can be started without a payment having been made or the vehicle leaving and without issuing a violation. In that case, the meter will continue to time for a predetermined period, say 15 minutes, and at the end of that second period will issue a violation if no payment is made. However if a payment is made during that period the amount of time accrued up until the point of payment will be deducted from the remaining paid period. If the vehicle leaves during that second period without payment then a violation is issued. In all of the foregoing situations, until a violation has issued the unit can display an indicator, such as a flashing green light, indicating to an observer that no parking violation has issued. Also as a further feature, the controller will calculate whether payment is being tendered by a driver for a period when the parking spot does not permit parking, such as rush hour or beyond a maximum parking period, and refuse to accept the payment in that case.

The microcontroller in payment unit 20 can be programmed so that the vehicle operator can select a “no fine” option upon payment. When the vehicle enters the parking space, the in-ground sensor 16 communicates the presence of the vehicle to unit 18 or 20 which takes a digital image of the license plate and commences the timer. Provided the user makes payment within the initial payment grace period there will be no violation. The user swipes his/her credit card in payment unit 20 and selects a “no fine” option for a premium charge. The system then automatically bills the credit card for an initial period, say one hour and then additional one hour increments as each hour expires, plus the premium, until the vehicle sensor senses that the vehicle has left the space. Or alternatively the system can calculate the exact time and bill the credit card accordingly, plus the premium, when the in-ground sensor senses that the vehicle has left the parking stall. A variation of this feature can be used where the system is combined with pay-by-phone parking. In those situations a vehicle operator has initiated a charge against a credit card by dialling a central server from a cell phone and entering a parking stall number to commence charging against a pre-authorized credit card. The in-ground sensor can signal controller when the vehicle leaves the stall which in turn signals the server to cease charges against the card. Currently the user must dial a second call to cut off the charges.

The microcontroller in payment unit 20 can be programmed so that the vehicle operator can pay the exact amount owing before leaving the parking spot. When the vehicle enters the parking space, the in-ground sensor 16 communicates the presence of the vehicle to unit 18 or 20 which takes a digital image of the license plate and commences the timer. The vehicle operator proceeds to the payment station 20 before leaving, pays the amount shown to be owing on the parking spot, and is given a time interval (e.g. 30 seconds) to return to the vehicle and exit before a violation is signalled. If the in-ground sensor 16 senses that the vehicle has left the stall without payment, or after the grace period has expired, then a parking violation is issued using the previously captured image and/or a newly captured image as the vehicle leaves.

The microcontroller in payment unit 20 can be programmed to provide the vehicle operator with a post-violation grace period which gives the operator an opportunity to pay for extra parking time after the pre-paid time has expired, or optionally pay a parking violation fine immediately at the time of the violation if the grace period has expired. When the vehicle enters the parking space, the in-ground sensor 16 communicates the presence of the vehicle to unit 18 or 20 which takes a digital image of the license plate and commences the timer. Provided the user makes payment for a parking duration within the initial payment grace period there will be no violation. If the grace period duration or the time paid for is exceeded, the microcontroller is programmed to record a violation. However, the controller can be programmed to provide a post-violation grace period, say 15 minutes, during which it permits the operator to pay for the additional expired time without issuing a violation. If the grace period is exceeded or the vehicle leaves without paying for the extra time, a violation is issued. In addition the system can provide the user an option to cancel a violation by paying a discounted fine prior to leaving the parking stall and/or within a further grace period. If the user leaves the stall without paying the fine or after the grace period has expired then the system communicates a violation with the captured digital image and a notice of the full fine is sent to the registered owner by mail. Again in instances where a violation has issued the unit can display an indicator, such as a flashing red light, indicating to an observer that a parking violation has issued. This will occur where the vehicle has been parked without paying, or longer than the time paid for, or beyond a maximum time or in a no-parking period or zone.

The microcontroller in payment unit 20 can be programmed to issue a parking violation and license image capture automatically after a maximum time has been exceeded or in certain other situations regardless of whether further or sufficient payment has been made. Such action would occur if the vehicle has parked during a no-parking period (rush hour), in a no-parking zone, or in excess of a stated maximum time. In that case the in-ground sensor 16 will sense the presence of the vehicle and signals the microprocessor which will issue a parking violation and license image capture immediately if one of the automatic violation criteria is present, or after the maximum time if the vehicle has not left the spot. Alternatively the microprocessor could cause a wireless signal to be sent to the towing company to signal that the vehicle can be immediately towed. As a variation, the in-ground sensor and/or digital camera can be used to analyse whether the same vehicle has returned to a stall to circumvent the maximum duration requirement. In that case firstly the system will not permit a further payment to be entered for a further parking duration beyond the maximum permitted until the in-ground sensor 16 senses that the vehicle has moved. A signature of the vehicle is taken by the digital camera and/or a sensor chip, and compared to a signature of the next vehicle to enter the parking stall within a fixed period, say 15 minutes. If the comparison indicates that the same vehicle has returned then the system will refuse to accept a further payment. Suitable sensor chips for this purpose are produced by Honeywell numbers HMC 1021 Z; HMC 1001; HMC 1052 and HMC 1053.

The system can add security features whereby if the payment unit 20 detects that the credit card matches a list of stolen cards, the image will be taken of the licence plate and communicated to authorities. Similarly in high security locations the digital camera can automatically scan the licence plate upon a vehicle being sensed, analyse the licence number and compare same to a list of high risk or stolen licence numbers which will then be communicated to authorities.

The present system is useful in conjunction with pay-by-phone parking systems. Under such systems a user registers with the system by providing a credit card authorization and cellphone number in association with the user's license plate number. The user wanting to pay for parking, phones into the service, which recognizes the cellphone number and prompts the user to key in a meter number or parking stall number. The system then prompts the user to enter the number of hours to be charged and commences timing. Once the time has expired a text message is sent to the user. Alternatively the user can have the charges running until the user calls back and terminates the parking time charge. With the present system the in-ground sensor will sense when the vehicle leaves the stall and cause a communication to be sent to the parking service. In the latter case that will cause the time charges to be terminated and in the former case will avoid the need for the parking service to send the text message to the user.

While a number of exemplary aspects and embodiments have been discussed above, those of skill in the art will recognize certain modifications, permutations, additions and sub-combinations thereof. While wireless communication between the vehicle sensors, digital cameras and central processor is preferred, the system could also be wired for communication. It is therefore intended that the following appended claims and claims hereafter introduced are interpreted to include all such modifications, permutations, additions and sub-combinations as are within their true spirit and scope.

What is claimed is:

1. A pay parking system for controlling a plurality of parking spaces, each parking space associated with a unique identifier, comprising:
i) a plurality of vehicle detection means each associated with one of said parking spaces for detecting the presence or absence of a vehicle in said one of said parking spaces, and comprising means for communicating a signal indicative of the presence or absence of a vehicle in said one of said parking spaces;
ii) a plurality of digital camera means each associated with one of said parking spaces and each adapted to be focussed at said one of said parking spaces in the area of the parking space where the licence plate of a parked vehicle is located, and comprising means for communicating a digital image of said licence plate of a parked vehicle;
iii) a payment acceptance means associated with said plurality of parking spaces for accepting payment for use of a parking space associated with one of said unique identifiers, comprising a microcontroller coupled with a timer such that the microcontroller initiates the timer for a prepaid parking interval upon receiving a signal from the payment acceptance means; and
iv) digital storage means for storing said digital image;
wherein the microcontroller initiates said digital camera to take an image of a vehicle license plate in one of said parking spaces when a vehicle is detected in said one of said parking spaces and communicating said digital image to a central parking authority if a parking violation is detected in respect of said one of said parking spaces.

2. The pay parking system of claim 1 further comprising:
v) telecommunications means coupled with said microcontroller, the microcontroller initiating a call notifying a remote monitoring station upon determining the existence of a parking violation and communicating said digital image.

3. The pay parking system of claim 1 wherein said microcontroller comprises a microprocessor.

4. The pay parking system as defined in claim 1 wherein the microcontroller initiates the timer for a predetermined standby interval upon receiving a signal from the vehicle detection means that a vehicle is present in the associated parking space, wherein said microcontroller is adapted to terminate the timing of the standby interval upon receiving a signal from the payment acceptance means, and said microcontroller causes said digital camera means to take a digital image of the licence plate of a vehicle in said associated parking space in the area of the parking space where the license plate of a parked vehicle is located after expiry of said standby interval without receiving a signal from said payment acceptance means that a payment has been made.

5. The pay parking system as defined in claim 1, wherein the microcontroller initiates the timer for a predetermined standby interval upon receiving a signal from the vehicle detection means that a vehicle is present in the associated parking space, wherein said microcontroller is adapted to terminate the timing of the standby interval upon receiving a signal from the payment acceptance means, and said microcontroller initiates the camera to take an image of the vehicle license palate after expiry of said standby interval without receiving a signal from said payment acceptance means that a payment has been made.

6. The pay parking system as defined in claim 1, wherein the microcontroller initiates the timer for a predetermined standby interval upon receiving a signal from the vehicle detection means that a vehicle is present in the associated parking space, the microcontroller is adapted to terminate the timing of the standby interval upon receiving a signal from the payment acceptance means, and the microcontroller initiates a call to said remote monitoring station as to a parking violation after the expiration of the standby interval without receiving a signal from said payment acceptance means that a payment has been made.

7. The pay parking system as defined in claim 1, wherein the microcontroller determines the existence of a parking violation upon the vehicle detection means signalling to the microcontroller the presence of a vehicle in the associated parking space after expiry of said prepaid parking interval.

8. The pay parking system as defined in claim 1, wherein said vehicle detection means communicate wirelessly with said microcontroller.

9. The pay parking system as defined in claim 1, wherein said digital camera means communicate wirelessly with said microcontroller.

10. The pay parking system as defined in claim 1, wherein said digital camera means functions as both said vehicle sensor and as digital camera means.

11. The pay parking system as defined in claim 1, wherein said digital camera means are mounted on free-standing above ground units in the vicinity of the associated parking space.

12. The pay parking system as defined in claim 1, wherein said digital camera means are located in the ground in the vicinity of the associated parking space.

13. The pay parking system as defined in claim 1, wherein said digital camera means are mounted above ground on fixed structures in the vicinity of the associated parking space.

14. A method of operating a pay parking system comprising a plurality of parking spaces, a plurality of vehicle sensors each associated with one of said parking spaces, a plurality of digital camera means each associated with a parking space and each adapted to be focussed at said parking space in the area of the parking space where the licence plate of a parked vehicle is located and a payment receiving device communicating with said vehicle sensors, said method comprising:
a) one of said vehicle sensors sensing the presence of a vehicle in a parking space;
b) taking a digital image of the vehicle licence plate in said parking space and starting a pre-payment grace period;
c) if the pre-payment grace period expires while the vehicle is still in the parking space, issuing a violation containing a digital image of the licence plate;
d) if a credit card payment is made in respect of the parking space during the pre-payment grace period, timing the pre-paid parking period;
e) if at the end of the pre-paid parking period a vehicle is still in the parking space, and a no-fine credit card option was not selected by the vehicle operator, issuing a violation with a digital image of the licence plate;
f) if at the end of the pre-paid parking period a vehicle is still in the parking space, and a no-fine credit card option was selected by the vehicle operator, charging an additional pre-paid parking period to said credit card and going back to step e).

15. The method of claim 14 wherein an additional grace period is provided after the pre-paid parking period has expired during which the vehicle operator can pay for the additional time after said expiry without a violation being issued.

16. The method of claim 14 wherein the vehicle operator can pay the fine for the violation at the payment receiving device.
